(19) United States
(12) Patent Application Publication
(10) Pub. No.: US 2016/0008230 A1
(43) Pub. Date: Jan. 14, 2016

(54) NIPPLE WITH PRESSURE-ADJUSTING VALVE

(71) Applicant: Siripen CHAITANARIT, Muang Samut Sakhon, Samut Sakhon (TH)

(72) Inventor: Siripen CHAITANARIT, Muang Samut Sakhon, Samut Sakhon (TH)

(73) Assignee: MAGIC LOVE LIMITED, Wanchai Hong Kong (CN)

(21) Appl. No.: 14/397,837

(22) PCT Filed: Sep. 11, 2012
(86) PCT No.: PCT/CN2012/081234

§ 371 Date: Feb. 20, 2015

(30) Foreign Application Priority Data
Apr. 30, 2012 (TH) 1201002002

(51) Int. Cl. A61J 11/00; A61J 11/02

(52) U.S. Cl. CPC A61J 11/002; A61J 11/0035; A61J 11/02

(57) ABSTRACT

A nipple with a developed pressure adjusting valve mounted in the bottom of air cavity of a mounting flange and shaped like a hollowed cylinder having a closed end, with the inside of the valve is used as a valve cavity for air flowing. A side wall of the valve above the bottom-closed end is formed with at least one slit at a part of periphery of the valve. Through the airflow passageway of the valve, the slit serves as an open-closed door to allow air to flow into the liquid-containing bottle advantageously, the air can flow into the liquid-containing bottle easily and conveniently, allowing the liquid to flow out from the bottle continuously and steadily, preventing the nipple from collapsing and preventing a vacuum formed inside the bottle as well as preventing the leakage of liquid from the valve when the bottle is inverted or sucked.

### FIELD OF THE INVENTION

The invention relates to engineering field. In particular, this invention relates to a nipple with pressure-adjusting valve.

### SUMMARY OF INVENTION

The nipple with the pressure adjusting valve comprises a hollowed cylinder shaped-pressure adjusting valve having a closed end, which is mounted to a valve cavity at a mounting flange The interior of the valve is used as a opening for air flowing. At a part of a periphery of said valve, a side wall of the valve positioned above the bottom-closed end is formed with at least one slit, which serves as opened-closed door to allow the ambient air to flow into the liquid-containing bottle via the valve cavity.

An objective of the present invention is to provide the nipple with the pressure adjusting valve in preferred embodiment and a more efficiency work. According to the present invention, it can be easily and conveniently put the air into the liquid-containing bottle thereby causing the liquid enabling to flow out from the bottle continuously and steadily, preventing the nipple from collapsing and preventing a vacuum from forming inside the bottle as well as preventing the leakage of liquid from the pressure adjusting valve when the bottle is inverted or sucked.

### BACKGROUND OF THE INVENTION

In past, a conventional feeding bottle comprises a liquid-containing bottle, which is provided for containing liquid such as milk, water or juice etc.; a nipple, which serves as a duct for exiting liquid from the liquid-containing bottle; a nipple cap, which is provided for fastening the nipple onto the liquid-containing bottle; a bottle cover, which is provided to seal a top end of the liquid-containing bottle. There are various shapes of the liquid-containing bottle, however, the top end of liquid-containing bottle is a cylinder shaped-lip having the screw-groove on outer surface of the bottle. The said screw-groove on outer surface of the bottle can match to the screw-groove on the inner surface of the nipple cap. The said nipple cap also is configured to tight-fittingly fasten a nipple onto a liquid-containing bottle. The bottle cover is fitted over the top end of the bottle and an inside of bottom end of the bottle is coupled appropriately to an outer surface of the nipple cap, and the bottle cover can be open for use as desired. Thus, the structure as mentioned above can form the inside of the liquid-containing bottle to have a closed system with an opening positioned on the top end of the nipple.

If the liquid-containing bottle is empty, generally, a range of air pressure inside the bottle is equal to that of the air pressure outside the bottle or if there is the liquid contained in the bottle placed in vertical, the range of air pressure pressing down on the top of the liquid contained in the bottle is still equal to that of the ambient pressure.

However, when the liquid-containing bottle is inverted, the air over the liquid in the bottle is flow down to the bottom end of the bottle instead. If a rest area of the air inside the bottle is small, it results in a low interior pressure, which cannot resist to the ambient pressure compressing around the nipple head being only a opening for exiting the liquid. Thereby, the liquid is stopped and unable to flow out of the bottle. For this reason, the user needs to exert more force to suck up the liquid.

Generally, the problems have been found that when the nipple has been sucked continuously for a long period without releasing the nipple from mouth, the vacuum condition is occurred in the bottle, resulting in the nipple collapsion, and difficult of releasing liquid because there is no air ventilation or air intake. When the user exert more force to suck up the liquid, the user may feel an ache at cheek pouch, or unable to suck up the liquid until allowing the air to flow into bottle again. When the vacuum condition is occurred, if the user continuously sucks up the liquid without releasing the nipple to sufficiently put the air into the bottle, the user might suck an air instead or the bottle may be adjoined to user's mouth.

There has been a development of an air putting method for adjusting an air pressure inside the bottle by inventing the pressure-adjusting valve for nipples in various shapes. In stead of direct ventilation through the liquid exiting channel at the end of nipple, the installment of air intake hole, air intake slit, or swell valve having slit parallel to liquid-containing bottle is used, thereby enabling to put the air into the bottle for adjusting the air pressure inside the bottle at the time of consumption. Nevertheless, the problem of unsteady air intake and the leakage of the liquid from the valve have still been found in the said pressure-adjusting valve.

For example, in using of nipple comprising of a convex valve having a slit in longitudinal and parallel to the liquid-containing bottle, the problem of the leakage of liquid and unsteady air intake have been found. This is because the said slit in longitudinal and parallel to the bottle is formed to separate the mounting flange of the valve into two parts so that the air pressure pressing down on the slit to open the valve is two-part distributed and is lowered. If air pressure acting on each side is not enough to push the valve against water pressure and gravitational force pressing down on another end of valve, the air cannot flow conveniently into the bottle. Consequently, user needs to exert more suction force to open the pressure-adjusting valve. However, if the pressure-adjusting valve is open too much, the liquid above the top of the valve is ready to flow and leak from the valve, by virtue of liquid weight and gravitational force etc.

As discussed above, the inventor improves the nipple comprising of the pressure-adjusting valve in preferred embodiment of the present invention to overcome the prior art's disadvantages and provide a more efficiency work.

### BRIEF DESCRIPTION OF THE DRAWING

FIG. 1 is a perspective view of a nipple comprising of the pressure-adjusting valve of the present invention

FIG. 2 is a front view of the nipple comprising of the pressure-adjusting valve of the present invention

FIG. 3 is the cross-sectional view of the pressure-adjusting valve of the present invention

FIG. 4 is the cross-sectional view of the pressure-adjusting valve of the present invention

FIG. 5 is the cross-sectional view of liquid-containing bottle with the nipple comprising of the pressure-adjusting valve of the present invention in use.

FIG. 6 is an enlarged view showing air flowing of liquid-containing bottle with the nipple comprising the pressure-adjusting valve of the present invention.

FIG. 7 is the cross-sectional view of side of nipple comprising of a pressure-adjusting valve which is in the open state to allow air to flow into liquid-containing bottle.

### DETAILED DESCRIPTION OF THE PRESENT INVENTION

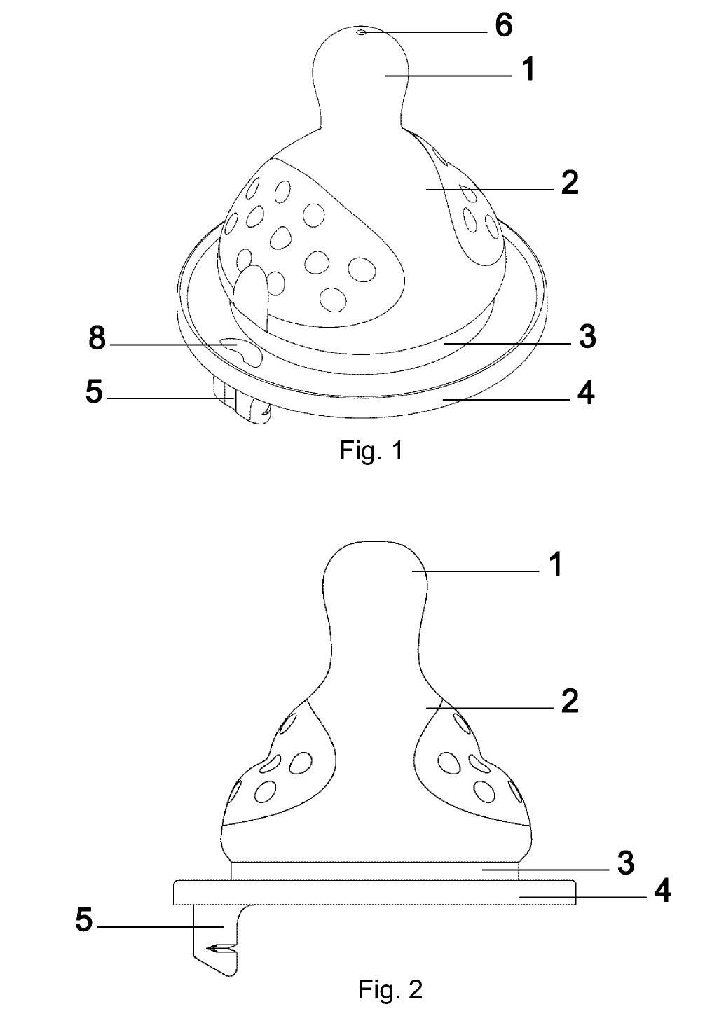

Referring to FIGS. 1 and 2, the nipple with the pressure-adjusting valve of the present invention is made of elastic material, such as synthetic rubber or natural rubber etc.

In embodiments of the present invention comprise of a nipple head 1, a nipple body 2, a nipple neck 3, a mounting flange 4, and a pressure-adjusting valve 5.

The nipple head 1 is a tip of nipple and is shaped a cylindrical-inverted dome. The nipple duct 6 is formed at the center of the tip of said nipple head 1. Further, the nipple body 2 is shaped the hallowed-inverted cone. A size of diameter of top end of the said nipple body 2 is equal to that of bottom end of the said nipple head 1. The size of diameter of bottom end of the nipple body 2 is equal to that of top end of nipple neck 3, which is larger than top end's diameter size of the said nipple body 2. The shape and surface of the nipple body 2 can be designed according to properties and utilities's requirement.

In an embodiment of the present invention, a hallowed-vertical cylinder shaped-nipple neck 3 is connected between the nipple body 2 and mounting flange 4. In some embodiment of the present invention, some type of nipple can be formed by connecting the nipple body 2 to the mounting flange 4 directly without the nipple neck 3.

A flat ring shaped-mounting flange 4, which is extended roundly and vertically from the nipple neck 3, is placed in parallel to a bottle lip 7. An air cavity 8, which is formed at the mounting flange 4, is connected to the pressure-adjusting valve 5 for air flowing to adjust the air pressure inside the bottle 7. The air cavity 8 for air flowing has a shape and size similar to a cavity positioned on top end of the valve 5 connected at the bottom of the mounting flange 4.

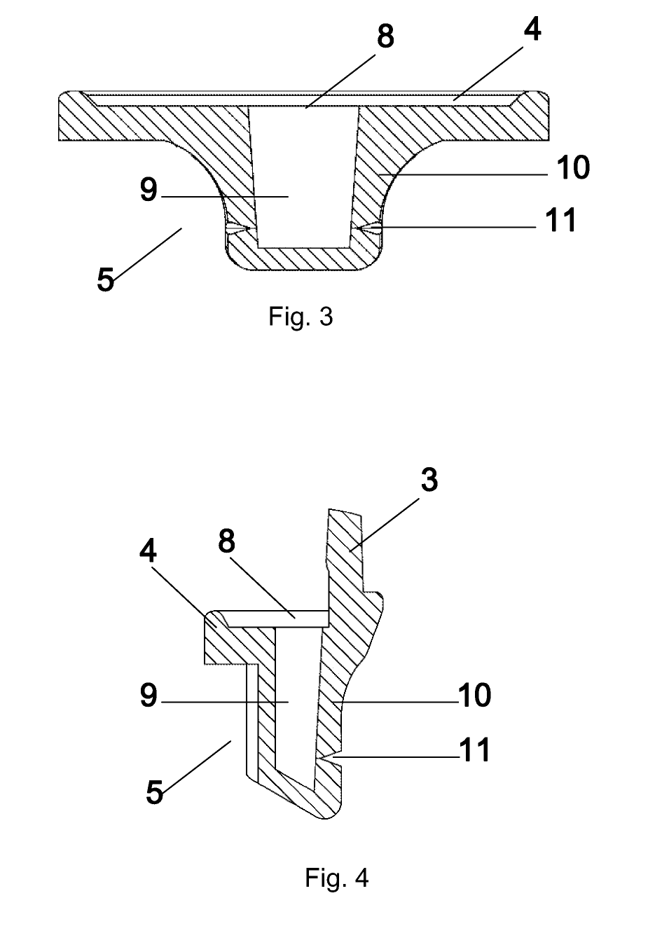

Referring to FIGS. 3 and 4, there are shown the cross sectional views of the front and the side of the pressure-adjusting valve of the present invention, respectively. The pressure-adjusting valve 5 is shaped a hallowed cylinder having one closed end and interior of the valve 5 is used as a valve cavity 9 for air flowing. The top end of the valve cavity 9 of the pressure-adjusting valve 5 is formed to be a open end connected the inside periphery of the said valve cavity 9 to an air cavity 8 at the mounting flange 4. To enhance strength of the valve 5, the external surface of top end of the valve 5 is extended to attach to the bottom surface of the mounting flange 4. In addition, a side wall 10 of the valve 5 above the bottom-closed end is formed with at least one slit 11 at the part of periphery of said valve 5. The slit 11 can be either continuous slit or spaced slits, which it depends upon the requirement and application. The slit 11 serves as opened-closed door to allow the ambient air to flow into the bottle through the valve cavity 9 located in the valve 5.

To enhance the slit 11 formed on a surface area of a side of the valve 5, the external surfaces of side wall 10 is additionally cut over and under slit 11 of the valve 5. The cuts of slit 11 are inwardly inclined toward each other so that the interior surface of the cuts of slit 11 is tightly closed and no space is formed within the interior surface of side wall 10. Thereby, a weight of the surface area of the side wall 10 can be reduced and an ambient air can be pushed into the inner conveniently.

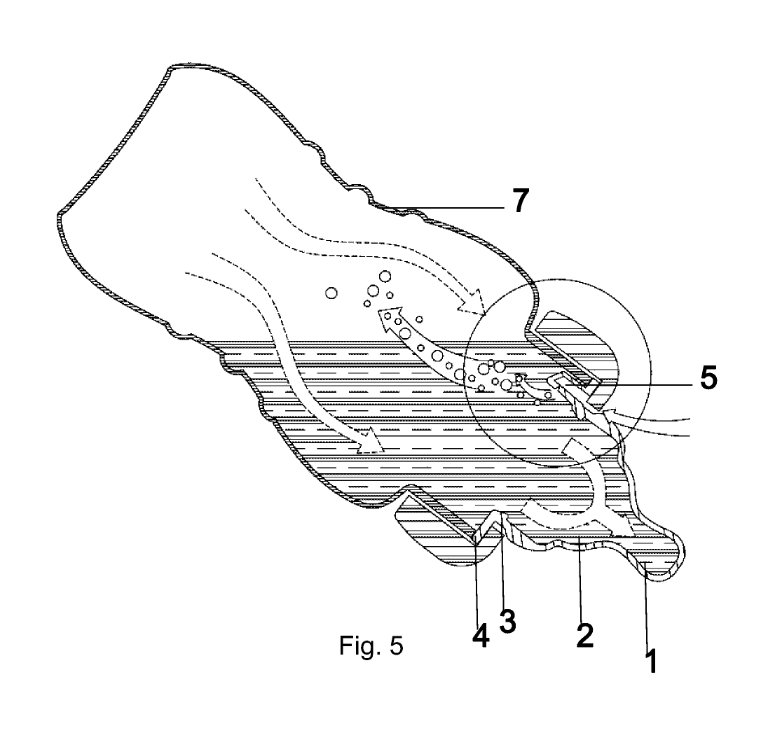

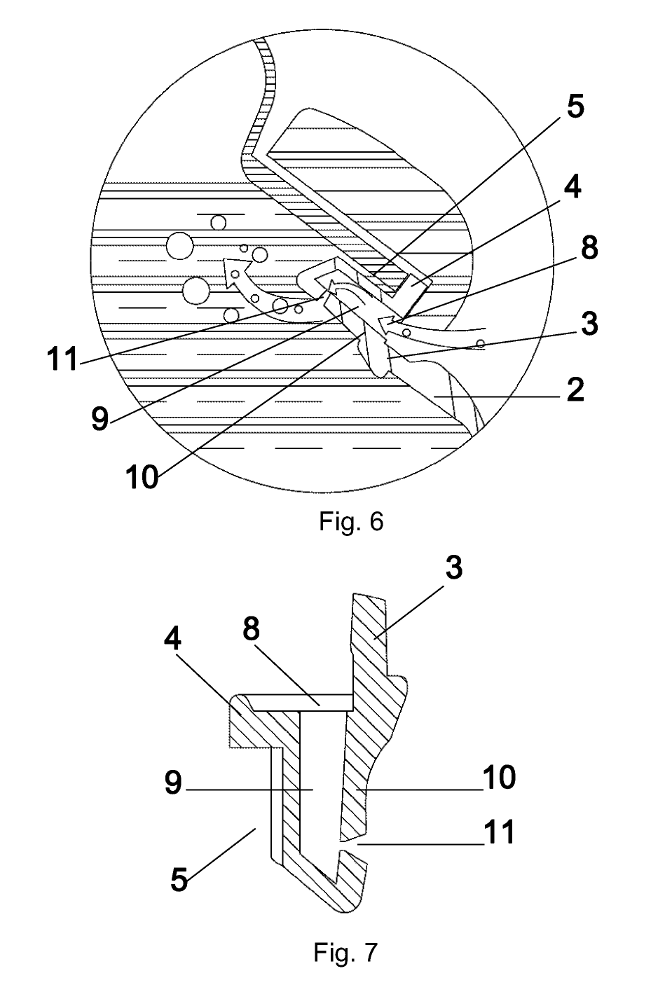

Referring to FIGS. 5, 6 and 7, there are shown the function of the pressure-adjusting valve 5. If the liquid-containing bottle 7 is emptily, normally, a range of the air pressure inside the bottle 7 is equal to that of the air pressure outside the bottle 7. This cause the slit 11 of the valve 5 is closed tightly. If there is the liquid in the liquid-containing bottle 7 placed vertically, the range of the air pressure pressing down on the liquid contained in the bottle 7 are kept equal to that of the external pressure or pressure of the valve cavity 9 of the valve so that the slit 11 is still tightly closed.

When the liquid-containing bottle 7 is inverted, the air over the liquid in the bottle 7 is flow down to the bottom end of the bottle instead. If a rest area of the air inside the bottle 7 is small, it results in a range of interior pressure lower than that of the air pressure outside the bottle 7. This is because, normally, the air will move from the area having a high air pressure to the area having a lower air pressure. And if there are various cavities for air flowing, the air will move to the cavity allowing the air to most convenient flow into the bottle.

In general, there is an air distribution in all direction. According to the present invention, there are two channels for air flowing into the liquid-containing bottle 7. One is the nipple duct 6 and another is the air cavity 8 of the mounting flange 4. Normally, it is difficult that the air can flow into the bottle 7 through the nipple duct 6 because the air compresses the nipple head 1 in all direction or the nipple head is sucked, resulting in the air flows through the air cavity 8 into the bottle instead. Moreover, the valve cavity 9 according to the present invention is formed with a bottom-closed end and at least one slit 11 is formed on the side wall of the valve cavity 9 as well. When the bottom end of the valve cavity 9 is pushed by the air thereabove, the slit 11 is open to allow the ambient air to continuously flow into the bottle having lower pressure.

When the user is sucking the nipple, the air will be put into the air cavity 8 of the mounting flange 4 to the valve cavity 9 of the valve 5 and pass through the open slit 11 into the interior of the bottle 7 in order to keep the balance of the pressure inside the bottle 7 and the pressure outside the bottle 7 all the time. This is to prevent a vacuum from forming inside the bottle when the bottle is sucked. With the aforesaid principle, function and reasons of the nipple according to the present invention, the obtained nipple with the pressure adjusting valve 5 can be put the air into the bottle 7 easily and conveniently, thereby causing the liquid enabling to flow out from the bottle 7 more continuously and steady.

In preferred embodiment, the nipple with the pressure-adjusting valve 5 of the present invention, which is able to prevent the liquid leakage from the valve 5 when the bottle is inverted or sucked. Due to the fact that the weight of liquid inside the bottle 7 above the pressure-adjusting valve 5 will press down at the bottom end of the valve 5 thereby causing the slit 11 of the side wall 10 is tightly closed enough to the liquid not to leak from the slit 11. The force of liquid acting to the slit 11 on the side wall 10 of the valve 5 is only a liquid pressure from the side wall 10 of the valve 5, without the gravitational force. Therefore, the pressure of liquid acting to the slit 11 at the side wall 10 of the pressure-adjusting valve 5 of the present invention is less than a liquid pressure acting to the slit 11 at the end of the valve 5 of the conventional nipple. When the user is sucking or the bottle is inverted, the user is able to suck from the bottle 7 continuously and conveniently and also there is no leakage of the liquid from the valve 5. Additionally, the nipple of the present invention can be detached and cleaned conveniently.

It will be understood that the invention as presented and claimed herein are used to illustrate and describe embodiments and examples merely, without any intention to limit the scope of the disclosure thereto. Various equivalent changes, alternations or modifications based on the claims of the disclosure are all consequently viewed as being embraced by the scope of the claim as appreciated by those skilled in the art.

### THE BEST MODE OF THE INVENTION

As stated in the detailed description of the invention above.

1. A nipple comprising a nipple head, a nipple body, a nipple neck, a mounting flange and a pressure adjusting valve,
wherein a cylindrical-inverted dome shaped nipple head, which is a tip of the nipple and is formed with a nipple duct at the center of the said nipple head; a hallowed-inverted cone shaped nipple body attached to a vertical-hallowed cylinder shaped nipple neck, which is mounted between the nipple body and the mounting flange; a flat ring shaped mounting flange extended from the nipple neck roundly and vertically; and an air cavity defined on the mounting flange, which is attached to the valve cavity of the pressure adjusting valve at the bottom of the mounting flange for allowing air to flow into liquid-containing bottle.
wherein the interior of the pressure adjusting valve is shaped a hallowed cylinder having closed-bottom end and the side wall of the pressure adjusting valve positioned over the closed-bottom end is formed with a slit at a part of periphery of said side wall of the pressure adjusting valve.

2. The nipple of claim 1, wherein at least one slit is formed at the part of periphery of the side wall of the pressure adjusting valve.

3. The nipple of claim 1, wherein the slit formed at the part of periphery of side wall of the pressure adjusting valve is a continuous slit.

4. The nipple of claim 1, wherein the slit formed at the part of periphery of side wall of the pressure adjusting valve is the spaced slits.

5. The nipple of claim 1, wherein the side wall is cut above and under the slit of the pressure adjusting valve and the cuts of slit are inwardly inclined toward each other so that interior surface of side wall is tightly closed and no space is formed within the interior surface of side wall.

6. The nipple of claim 1, wherein the nipple is made of elastic material.

7. The nipple of claim 2, wherein the slit formed at the part of periphery of side wall of the pressure adjusting valve is a continuous slit.

8. The nipple of claim 2, wherein slit formed at the part of periphery of side wall of the pressure adjusting valve is the spaced slits.

9. The nipple of any of claim 2, wherein side wall is cut above and under slit of the pressure adjusting valve and the cuts of slit are inwardly inclined toward each other so that interior surface of side wall is tightly closed and no space is formed within the interior surface of side wall.

10. The nipple of any of claim 3, wherein side wall is cut above and under slit of the pressure adjusting valve and the cuts of slit are inwardly inclined toward each other so that interior surface of side wall is tightly closed and no space is formed within the interior surface of side wall.

11. The nipple of any of claim 4, wherein side wall is cut above and under slit of the pressure adjusting valve and the cuts of slit are inwardly inclined toward each other so that interior surface of side wall is tightly closed and no space is formed within the interior surface of side wall.

12. The nipple of claim 2, wherein the nipple is made of elastic material.

13. The nipple of claim 3, wherein the nipple is made of elastic material.

14. The nipple of claim 4, wherein the nipple is made of elastic material.

15. The nipple of claim 5, wherein the nipple is made of elastic material.
